(19) United States
(12) Patent Application Publication
(10) Pub. No.: US 2007/0252487 A1
(43) Pub. Date: Nov. 1, 2007

(54) MOTOR AND PUMP HAVING MAGNETIC SENSOR, CONNECTING METHOD BETWEEN CIRCUIT BOARD HAVING MAGNETIC SENSOR AND STATOR, AND MANUFACTURING METHOD OF MOTOR AND PUMP

(75) Inventors: Yoshio FUJII, Kyoto (JP); Kenichirou HAMAGISHI, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku, Kyoto (JP)

(21) Appl. No.: 11/740,600

(22) Filed: Apr. 26, 2007

(30) Foreign Application Priority Data
Apr. 28, 2006 (JP) 2006-126648

(51) Int. Cl. H02K 11/00; H02K 21/12

(52) U.S. Cl. 310/68 B; 310/156.06

(57) ABSTRACT

A motor includes a sensor holder that is integral with an annular ring of an insulator of a stator. At least a portion of a Hall element is accommodated in the sensor holder. By virtue of such configuration, a position of the Hall element with respect to the stator will be determined with precision.

### BACKGROUND OF THE INVENTION

1. Field of the Invention

The present invention relates to a motor having a magnetic sensor arranged to detect a position of a magnetic pole, and also relates to a pump for circulating water. In particular, the present invention is preferably used in a motor vehicle equipped with a hybrid engine for circulating water. Also, the present invention relates to a connecting method between a circuit board having the magnetic sensor and a stator. Also, the present invention relates to a manufacturing method of the motor using the connecting method. Also, the present invention relates to a method of manufacturing the pump.

2. Description of the Related Art

In recent years, in order to improve the fuel efficiency of a motor vehicle, an application of a hybrid engine has been developed in which the engine has loaded thereon, as an actuator, an electrically powered motor and an engine. Due to such development, many types of electrical equipment have also been developed so as to be used in the actuator. In particular, in the hybrid engine, a battery used therein is a critical component. However, an output of the battery is easily influenced by a temperature of an environment surrounding it. Therefore, in order to maintain the temperature of the environment surrounding the battery at a certain level, the battery needs to be cooled by circulating water so as to dissipate the heat generated by the battery.

FIG. 13 is a schematic cross sectional view of a conventional pump.

According to FIG. 13, a pump 1 includes a partition 4 having a cylindrical shape with a bottom separating a pump chamber 2 from an electrical control portion 3, a lower case 5 for accommodating therein the electrical control portion 3, an upper case 6, having an intake portion and a discharge portion, connected to the lower case 5 and the partition 4, an impeller 7 having a rotor magnet 7a which is arranged at an inner circumferential surface of the partition 4, a stator 8 arranged at an outer circumferential surface of the partition 4, and a circuit board 9 which is arranged opposite to a bottom portion 4a of the partition 4 and is electrically connected to the stator 8. Also, a Hall element 9a is mounted on a top surface of the circuit board 9 such as to oppose to an end surface of the rotor magnet 7a.

However, since the Hall element 9a has no way of adjusting a position thereof with respect to the stator 8, the position of the Hall element 9a with respect to the stator 8 in a circumferential direction is determined each time the pump 1 is assembled. Therefore, the position of the Hall element 9a may differ for each pump 1, thereby affecting characteristics of the pump 1 differently for each pump 1.

Further, the bottom portion 4a of the partition 4 is arranged between the rotor magnet 7a and the Hall element 9a. Therefore, the space between the rotor magnet 7a and the Hall element 9a needs to be large enough to include the partition 4. Thus, a thickness of the bottom portion 4a needs to be thin. However, the bottom portion 4a is where a great deal of water pressure is applied due to the rotation of the impeller 7. Therefore, a thinly designed bottom portion 4a may be damaged by the water pressure, causing water leakage from the pump chamber 2.

On the other hand, when the bottom portion 4a is designed to have a thickness that is large enough to prevent the water leakage, the distance between the rotor magnet 7a and the Hall element 8a also becomes great, which may compromise the ability of the Hall element 9a to detect the position of the magnetic poles of the rotor magnet 7a. As a consequence thereof, there may be a problem that the rotation of the impeller 7a is not adequately controlled.

Further, since the Hall element 9a is connected by soldering to the circuit board 9, a vibration of the circuit board 9 conducted from the pump 1 may damage the Hall element 9a. Since there is no countermeasure to address the damage to the Hall element 9a, the pump 1 is not reliable.

### SUMMARY OF THE INVENTION

In order to overcome the problems described above, preferred embodiments of the present invention provide a motor including a stator core having a core back portion with a ring shape arranged in a concentric manner about a rotational axis and a plurality of tooth portions evenly arranged in a circumferential manner each extending inward to the rotational axis, an insulator covering at least a portion of a stator core and the plurality of tooth portions, and a plurality of coils each formed by winding a wire around each tooth portion along with the insulator. An annular ring is arranged so as to connect an innermost surface of each tooth portion with the insulator. A sensor holder for accommodating a portion of the magnetic sensor is arranged on the annular ring in an integral manner. The stator is preferably used in a motor or in a pump. The motor and the pump according to preferred embodiments of the present invention each preferably have a two-phase structure and four tooth portions.

Also, in a manufacturing method of the stator according to another preferred embodiment of the present invention, the tooth portions and the insulator are connected to one another, and then the coils are formed by winding a wire around each tooth portion, wherein the tooth portions and the core back portion are initially provided separately. Then the core back portion is affixed to the tooth portions.

Also, in a connecting method between the stator and the circuit board according to a preferred embodiment of the present invention, the magnetic sensor is accommodated in the sensor holder, and then, the circuit board and the magnetic sensor are connected to one another.

Other features, elements, steps, characteristics and advantages of the present invention will become more apparent from the following detailed description of preferred embodiments thereof with reference to the attached drawings.

### BRIEF DESCRIPTION OF THE DRAWINGS

FIG. 1 is a schematic cross sectional view in an axial direction according to a preferred embodiment of a pump of the present invention.

FIG. 2 is a plan view of a stator according to a preferred embodiment of the present invention as viewed from above.

FIG. 3 is a perspective view of the stator omitting a depiction of a coil according to a preferred embodiment of the present invention.

FIG. 4a is an enlarged view of a sensor holder of an insulator according to a preferred embodiment of the present invention.

FIG. 4b is a schematic cross sectional view of the sensor holder as viewed from an x-x line shown in FIG. 4a.

FIG. 5 is a bottom view of the stator according to a preferred embodiment of the present invention having assembled thereon a partition.

FIG. 6 is a flow chart illustrating a flow of steps of a manufacturing process of the stator according to another preferred embodiment of the present invention.

FIG. 7 is a perspective view of a Hall element.

FIG. 8 is a schematic plan view of a circuit board according to a preferred embodiment of the present invention as viewed from above.

FIG. 9a is a perspective view of a guiding element according to a preferred embodiment of the present invention.

FIG. 9b is a schematic cross sectional view of the guiding element according to a preferred embodiment of the present invention.

FIG. 10 is a flow chart illustrating a flow of steps of a connecting method for connecting the stator and the circuit board.

FIG. 11 is a flow chart illustrating a flow of steps of a manufacturing process of the pump according to a preferred embodiment of the present invention.

FIG. 12 is a schematic cross sectional view of a sensor holder.

FIG. 13 is a cross sectional view of a conventional pump.

### DETAILED DESCRIPTION OF PREFERRED EMBODIMENTS

### <Structure of a Pump>

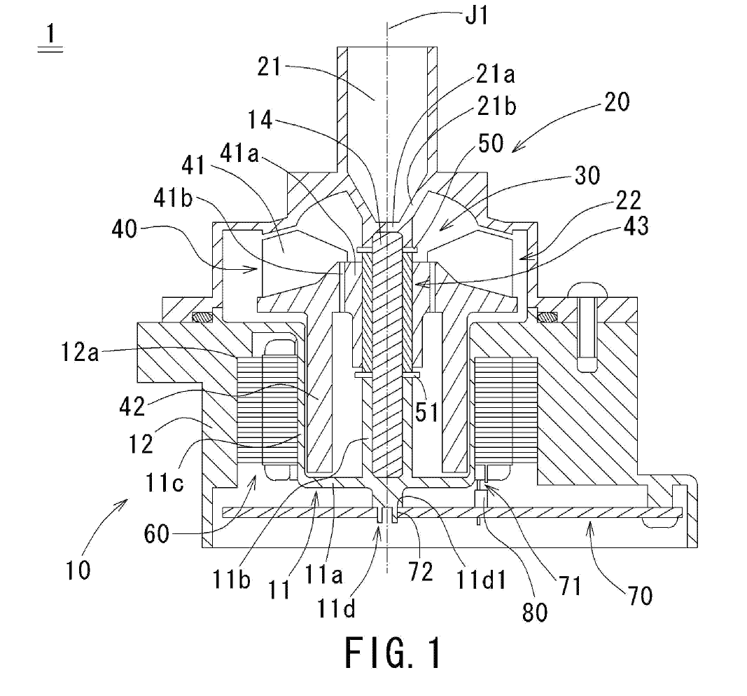

Hereinafter, a first preferred embodiment of a pump according to the present invention will be described with reference to FIG. 1. FIG. 1 is a schematic cross sectional view of a pump 1. Note that in the description of the preferred embodiments herein, words such as upper, lower, left, right, upward, downward, top and bottom for describing positional relationships between respective members and directions merely indicate positional relationships and directions in the drawings. Such words do not indicate positional relationships and directions of the members mounted in an actual device. Also note that reference numerals, figure numbers and supplementary descriptions are shown below for assisting the reader in finding corresponding components in the description of preferred embodiments below to facilitate the understanding of the present invention. It is understood that these expressions in no way restrict the scope of the present invention.

According to FIG. 1, a lower case 10 includes a partition 11 having a cylindrical or substantially cylindrical shape with a bottom arranged in a concentric manner with a rotational axis J1. Also, the lower case 10 includes a case cylindrical portion 12 which is arranged concentrically with a partition 11 and has a space therewith in a radial direction. The case cylindrical portion 12 configures a portion of an outer radius of the pump 1. The lower case 10 which is preferably made of a resin material is preferably formed by an injection molding.

Also, a substantially cylindrically shaped shaft fixing portion 11b extending in the axial direction is arranged at a position concentric with the rotational axis J1 of a bottom portion 11a of the partition 11. An outer circumferential surface of the shaft 14 is affixed to an inner circumferential surface of the shaft fixing portion 11b. With this structural arrangement, the shaft 14 is arranged in a concentric manner with the rotational axis J1.

The upper case 20 is arranged on a top surface of the lower case 10. By virtue of such configuration, a space defined between the upper case 20 and the partition 11 is a pump chamber 30. The upper case 20 includes a substantially cylindrically shaped intake portion 21 through which water is taken in to the pump chamber 30 from an outside of the pump 1. The upper case 20 also includes a substantially cylindrically shaped discharge portion (not shown) through which water is discharged from the pump chamber 30.

The pump chamber 30 includes an impeller 40 which is a rotor and circulates water inside the pump chamber 30. The impeller 40 is preferably a single component made of a ferrite magnet. The impeller 40 includes a plurality of blade portions 41 for circulating water, and a magnetic drive portion 42 which rotates due to a magnetic effect. An inner circumferential cylindrical portion 41a extending in an axially downward direction is arranged at an inner circumferential surface of the blade portion 41. A substantially cylindrically shaped bearing member 43 which slidably contacts an outer circumferential surface of the shaft 14 is arranged at an inner circumferential surface of the inner circumferential cylindrical portion 41a. Also, a plurality of through holes 41b penetrating in the axial direction between the inner circumferential cylindrical portion 41a and the magnetic drive portion 42 are arranged in a circumferential manner. The through holes 41b substantially maintain a water balance within the pump chamber 30 at a certain level.

The blade portions 41 of the impeller 40 each extend in the radial direction. Therefore, the upper case 20 has formed therein an enlarged accommodation portion 22 in order to accommodate the blade portions 41. The blade portions 41 are accommodated in a space between a top surface of the lower case 10 and the enlarged accommodation portion 22. At the enlarged accommodation portion 22, a spiral current is generated due to a rotation of the impeller 40.

An outer circumferential surface of a substantially cylindrically shaped magnetic drive portion 42 is opposed to an inner circumferential surface of a cylindrical portion 11c of the partition 11 with a radial gap interposed therebetween. A plurality of magnetic poles are circumferentially arranged on the outer circumferential surface of the magnetic drive portion 42.

The intake portion 21 includes a cylindrical shaft retaining portion 21a having a bottom portion for accommodating an upper portion of the shaft 14, and a joining portion 21b for joining the shaft retaining portion 21a and the intake portion 21. The bearing member 43 is arranged in an axial space between the shaft retaining portion 21a and the shaft fixing portion 11b. An upper support member 50 is arranged between a top end of the bearing member 43 and a bottom end of the shaft retaining portion 21a. A lower support member 51 is arranged between a bottom end of the bearing member 43 and a top end of the shaft fixing portion 11b. The upper support member 50 and the lower support member 51 are preferably both made of a material having a superior slidability.

A stator 60 is arranged between an outer circumferential surface of the partition 11 and an inner circumferential surface of the case cylindrical portion 12. A step portion 12a extending radially inward is formed at an upper portion in the axial direction of the case cylindrical portion 12. The axial position of the stator 60 is determined by the step portion 12a.

A substantially cylindrically shaped protruded portion 11d extending downward is formed at a portion of the bottom portion 11a axially below the rotational axis J1. A circuit board 70 having a through hole 72 through which the protruded portion 11d is inserted is arranged axially below and opposing to the bottom portion 11a. A Hall element 71 is arranged at a top surface of the circuit board 70. The Hall element 71 is arranged radially opposing to the outer circumferential surface of the magnetic drive portion 42. A step portion 11d1 includes a portion whose diameter is smaller than the inner diameter of the through hole 72 and which is to be inserted in to the through hole 72, and a portion whose diameter is greater than the inner diameter of the through hole 72.

A magnetic field is generated when electricity is conducted to the stator 60 from an external power supply (not shown). Then a magnetic circuit is generated between the magnetic drive portion 42 and the stator 60, and consequently a torque centered about the rotational axis J1 is generated and rotates the impeller 40, thereby generating a water current in the pump chamber 30.

### <Structure of Stator>

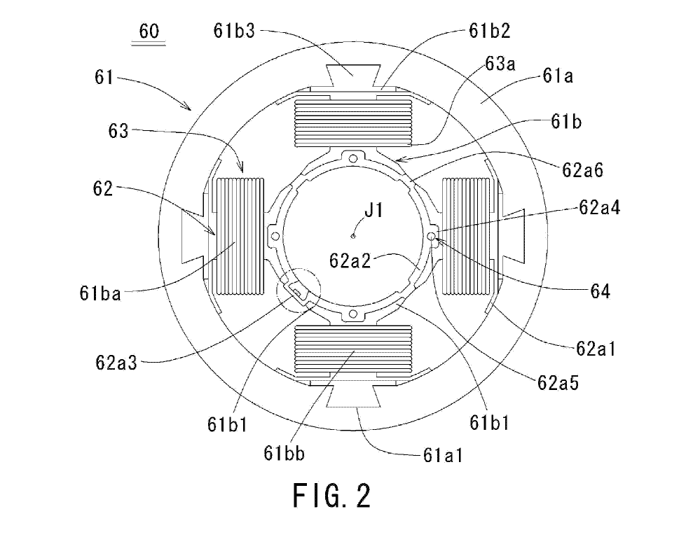

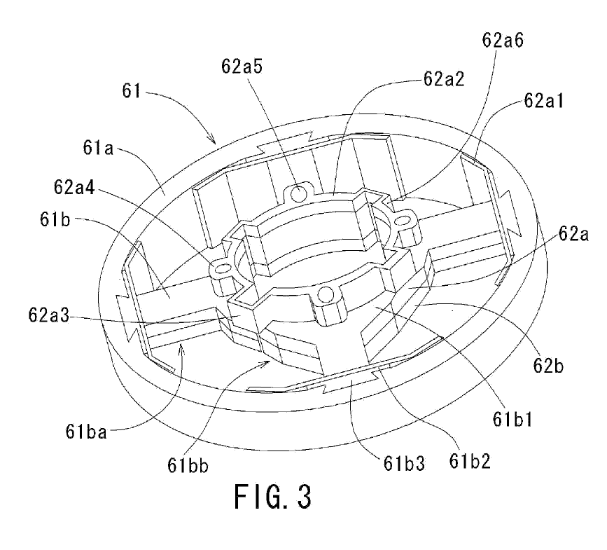

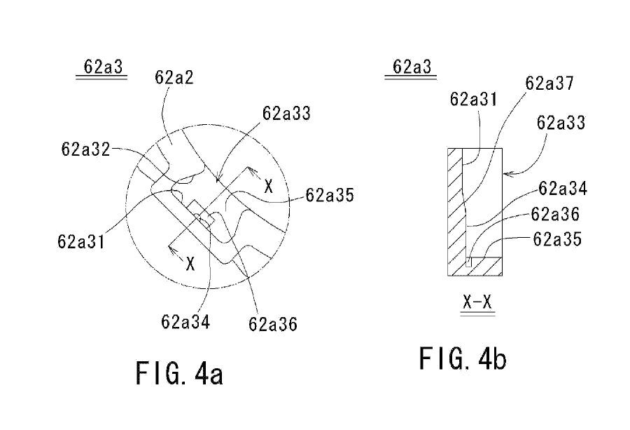

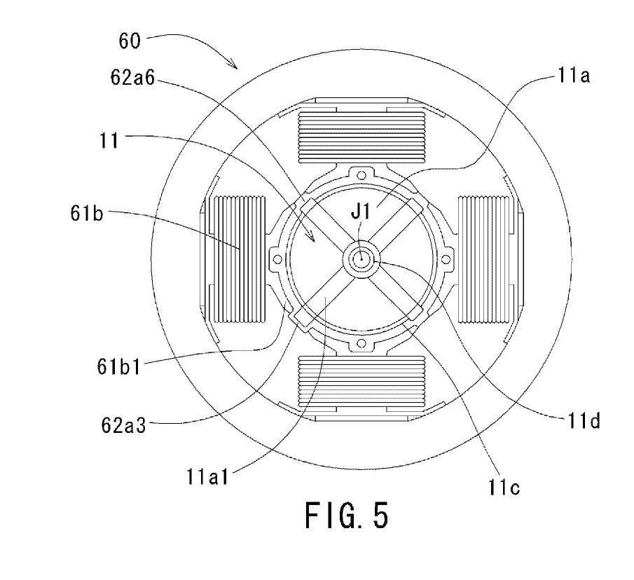

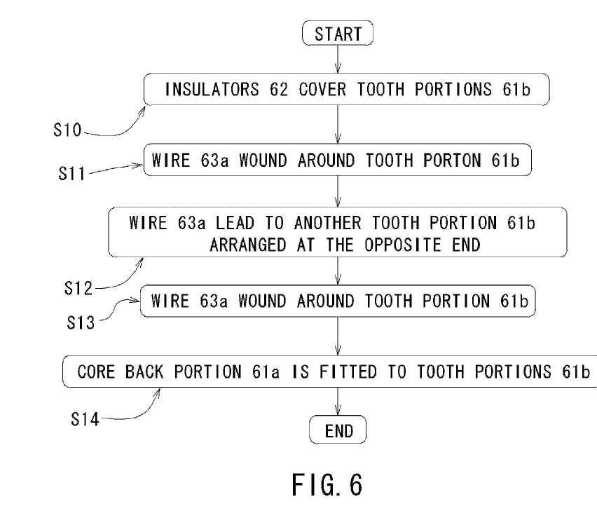

Hereinafter, a structure of the stator 60 according to the present preferred embodiment of the present invention will be described with reference to FIGS. 2 to 6. FIG. 2 is a plan view of the stator 60. FIG. 3 is a perspective view of the stator 60 omitting a depiction of a coil 63. FIG. 4a is an enlarged view of a sensor holder 62a3. FIG. 4b is a schematic cross sectional view of the sensor holder 62a3. FIG. 5 is a bottom view showing the stator 60 having assembled thereon the partition 11. FIG. 6 is a flow chart illustrating a flow of steps of manufacturing the stator 60.

According to FIGS. 2 and 3, the stator 60 includes a stator core 61 having an annular shaped core back portion 61a and preferably four tooth portions 61b arranged evenly apart from one another in a circumferential manner each extending radially inward, two insulators 62 arranged to cover the stator core 61 from a top side and a bottom side of the stator core 61, and a plurality of coils 63 (preferably four in the present preferred embodiment, for example) each of which are formed by winding the wire 63a around the tooth portion 61b via the insulator 62.

The stator core 61 is preferably made of a plurality of thin magnetic plates laminated on top of another in the axial direction. Also, the insulator 62 is preferably made of resin material having an electrically insulating quality by an injection molding. The coils 63 each are formed by winding a wire 63a which is a copper wire coated by an insulating layer around each tooth portion 61b.

The stator 60 preferably has a two-phase structure, thereby reducing a number of electronic components required to control a rotation of the rotor compared with a number of electronic components required to control a rotation of the rotor of a motor having a three-phase structure.

A circumferential direction extending portion 61b1 extending in the circumferential direction is arranged at a radially innermost portion of the tooth portion 61b. An innermost surface of the circumferential direction extending portion 61b1 is opposed to an outer circumferential surface of the magnetic drive portion 42. At a portion of each tooth portion 61b connected to the core back portion 61a, an extending portion 61b2 extending in substantially circumferential directions (i.e., substantially perpendicularly with respect to the radial direction of each tooth portion) and a fitting portion 61b3 extending radially outward are arranged.

A portion of an inner circumferential surface of the core back portion 61a radially corresponding to the extending portion 61b2 is preferably flat so as to accommodate the extending portion 61b2. Also, a fitting portion 61a1 is formed at the portion of the core back portion 61a radially connected to the fitting portion 61b3. Note that portions connecting the flat area at the inner circumferential surface of the core back portion 61a are curved.

According to FIG. 3, the insulator 62 includes a lower insulator 62a and an upper insulator 62b each having a substantially an identical shape. The lower insulator 62a and the upper insulator 62b cover respectively the top side and the bottom side of the tooth portion 61b.

Since the lower insulator 62a and the upper insulator 62b each are shaped substantially the same, hereinafter, the lower insulator 62a will be described. The lower insulator 62a includes at an outer circumferential surface thereof an outer cover portion 62a1 which makes contact with an inner circumferential surface of the extending portion 61b2 of the tooth portion 61b, and extends radially outward so as to make contact with the inner circumferential surface of the core back portion 61a. When the outer cover portion 62a1 makes contact with the inner circumferential surface of the extending portion 61b2, the outer cover portion 62a1 will be deformed such that the shape thereof adjusts to the contacting portion the extending portion 61b2. Therefore, when the tooth portion 61b and the core back portion 61a are connected to one another, the outer cover portion 62a1 will not interfere therewith, whereby the connecting the tooth portion 61b to the core back portion 61a will be facilitated and the productivity of the manufacturing of the stator 60 will be increased.

An annular ring 62a2 of substantially annular shape is arranged axially upward at the inner circumferential surface of the lower insulator 62a along the innermost surface of the tooth portion 61b. By virtue of the annular ring 62a2 connecting the insulator with each tooth portion 61b, a number of components required will be reduced.

According to the preferred embodiment shown in FIG. 2, a sensor holder 62a3 for accommodating therein the Hall element 71 is provided at a portion of the inner circumferential surface of the annular ring 62a2 between two immediately adjacent circumferential direction extending portions 61b1 (i.e., between the tooth portions 61ba and 61bb). The sensor holder 62a3 is formed with the annular ring 62a2 in an integral manner, and therefore, a circumferential position of the sensor holder 62a3 will be determined within a margin of manufacturing error. Consequently, the circumferential position of the Hall element 71 accommodated in the sensor holder 62a3 will be determined easily and with precision with respect to the tooth portions 61ba and 61bb. Note that although it is described that the sensor holder 62a3 for accommodating therein the Hall element 71 is preferably located at the portion between two of the immediate adjacent circumferential direction extending portions 61b1, the position of the sensor holder 62a3 is not limited thereto. The position of the sensor holder 62a3 may be modified in the circumferential direction in accordance with characteristics (e.g., angle of lead or angle of lag) of the Hall element 71 accommodated therein.

A radial direction protruded portion 62a4 is arranged at a portion of the lower insulator 62a corresponding to each tooth portion 61b. The radial direction protruded portion 62a4 includes an opening portion 62a5 penetrating therethrough toward the tooth portion 61b. A connecting pin 64 made of a conductive material is fixed at the opening portion 62a5 (see FIG. 2). In particular, the connecting pin 64 according to the present preferred embodiment is press fitted to the opening portion 62a5. Also, a plurality of circumferential indent portions 62a6 (preferably three in the present preferred embodiment, for example) indented in the radially outward direction are arranged on the annular ring 62a2, wherein each circumferential indent portion 62a6 is arranged equally spaced apart from one another and the sensor holder 62a3.

According to FIG. 4a, the sensor holder 62a3 is formed such that a portion of the inner circumferential surface of the annular ring 62a2 is radially indented in an outward direction. The sensor holder 62a3 includes at an inner portion thereof furthest from the rotational axis a flat back end surface 62a31 which is substantially perpendicular to the rotational axis J1. Radial surfaces (hereafter referred to as inclined surfaces 62a32) of the sensor holder 62a3 each extending radially inward from the back end surface 62a31 are radially inclined such that a distance between the inclined surfaces becomes shorter toward the rotational axis. The distance between the inclined surfaces is shortest at an opening portion 62a33. A circumferential width of the opening portion 62a33 at the opening portion 62a33 is approximately equal to or smaller than a circumferential width of the Hall element 71.

A protruded portion 62a34 protruded radially inward is arranged at the back end surface 62a31. A portion of the protruded portion 62a34 makes contact with the Hall element 71. According to FIG. 4b, an upper portion of the protruded portion 62a34 is connected to the back end surface 62a31 via an inclined surface 62a37. By virtue of such configuration, the Hall element 71 is more easily inserted into the sensor holder 62a3. The sensor holder 62a3 also includes a bottom surface 62a35 which opposes an axial end surface of the Hall element 71, and an indented portion 62a36 indented downward at a portion thereof the protruded portion 62a34 makes contact therewith. Since the indent portion 62a34 is formed at a portion at which the protruded portion 62a34 and the bottom surface 62a35 meet one another, the Hall element 71 will be well guided in the radial direction by the inclined surface 62a37 and accommodated with precision.

Hereinafter, a relationship between the circumferential indent portion 62a6, the lower case 10 and the partition 11 will be described with reference to FIG. 5.

The partition 11 includes a plurality of ribs 11a1 (preferably four in the present preferred embodiment, for example) each extending in the radial outward direction from the protruded portion 11d arranged on the bottom portion 11a so as to ensure a predetermined axial thickness of the cylindrical portion 11c are arranged in the circumferential direction equally apart from one another. The ribs 11a1 are formed integrally with the cylindrical portion 11c. A circumferential width between each rib 11a1 is preferably equal to that between each circumferential direction extending portion 61b1. By virtue of such relationship, a circumferential position of the stator 60 will be determined by the ribs 11a1. Also, the ribs 11a1 reduce a circumferential movement of the stator 60 with respect to the lower case 10.

It is preferable that the cylindrical portion 11c of the partition 11 has a thin radial thickness (approximately 0.4 mm in the present preferred embodiment) so as to improve an effectiveness of the magnetic field generated within the stator 60. However, it is difficult to manufacture the cylindrical portion 11c having a very thin radial thickness due to a difficulty of injecting a resin material into a mold designed for the very thin radial thickness. Therefore, providing the ribs 11a1 to the cylindrical portion 11c allow the resin material to be injected smoothly and thus reduce the difficulty of injecting the resin material into the mold designed for the cylindrical portion 11c having the very thin radial thickness. Also, the ribs 11a1 provide a durability to the cylindrical portion 11c having the very thin radial thickness, thereby minimizing a conduction of vibration generated by the stator 60 to the pump chamber 30. By virtue of such configuration, the cylindrical portion 11c has the thin radial thickness while the lower case 10 having the partition 11 is manufactured effectively and the durability of the cylindrical portion 11c is enhanced.

Also, it is preferable that the rib 11a1 is not arranged at the portion of the cylindrical portion 11c corresponding to the sensor holder 62a3. In general, it is preferable that the Hall element 71 is arranged radially near the outer circumferential surface of the magnetic drive portion 42 in order to effectively detect a magnetic flux generated by the magnetic drive portion 42. If the rib 11a1 is arranged at the portion of the cylindrical portion 11c corresponding to the sensor holder 62a3, a radial distance between the Hall element 71 and the magnetic drive portion 42 will be greater, thus reducing an effectiveness of the Hall element 71 to detect the magnetic flux generated by the magnetic drive portion 42. Therefore, according to the present preferred embodiment, the rib 11a1 is not arranged at the portion of the cylindrical portion 11c corresponding to the sensor holder 62a3 in which the Hall element 71 is accommodated.

At the portion of the cylindrical portion 11c corresponding to the rib 11a1, the circumferential indent portion 62a6 of the insulator 62 is provided. A circumferential width of the circumferential indent portion 62a6 is substantially equal to that of the rib 11a1. The ribs 11a1 each are accommodated in each corresponding circumferential indent portion 62a6. By virtue of such configuration, the ribs 11a1 prevent more effectively the circumferential movement of the stator 60 with respect to the lower case 10.

### <Manufacturing Method of the Stator>

Hereinafter, a manufacturing method of the stator 60 will be described with reference to FIG. 6.

The lower insulator 62a, having fixed thereon the connecting pins 64 at each corresponding opening portion 62a5, and the upper insulator 62b cover the four tooth portions 61b (step S10). Then the wire 63a is wound around the connecting pin 64 of the predetermined tooth portion 61b, wherein at least a portion of an end of the wire 63a affixed to the connecting pin 64 is uninsulated.

Then, the wire 63a is wound around the predetermined tooth portion 61b so as to form the coil 63 (step S11). Since one end of the wire 63a is already affixed to the connecting pin 64, the wire 63a will have an appropriate tension when being wound around the tooth portion 61b.

Then, when one coil 63 is formed around one tooth portion 61b, the wire 63a coming off the coil 63 is led to another tooth portion 61b arranged 180 degrees apart from the said coil 63 (step S12). The wire 63a traveling between the two tooth portions 61b makes contact with the outer circumferential surface of the annular ring 62a2. In particular, the wire 63a travels in a contact manner with the outer circumferential surface of the sensor holder 62a3.

At the tooth portion 61b arranged 180 degrees apart from the coil 63, an additional coil 63 is formed (step S13). Then a portion of the wire 63a coming off the additional coil 63 formed in the step S13 is uninsulated and fixed. Note that since two wires 63a are used in the stator 60, the procedures taken in steps S11 through S13 are repeated with two other tooth portions 61b.

Finally, the core back portion 61a is fitted to outermost surfaces of the tooth portions 61b (step S14).

By virtue of the aforementioned steps for manufacturing the stator 60, it becomes possible to supply the wire 63a from an outermost surface of the tooth portions 61b. Consequently, the winding of the wires 63a around the tooth portions 61b can be executed quickly while a number of times that the wire 63a is wound around the coil 63 can be increased, and therefore, characteristics of the motor can be improved.

Further, since the annular ring 62a2 is formed, the wire 63a traveling between tooth portions 61b will be well protected. Also, the wiring around the tooth portions 61b will be executed continuously and effectively. Also, since the wire 63a travels along the circumference of the annular ring 62a2, the wire 63a maintains an appropriate tension when forming the coils 63, and therefore, no wire 63a loosely hanging from the circumference of the annular ring 62a2 will make contact with another component of the motor potentially damaging the wire 63a.

### <Hall Element and Circuit Board>

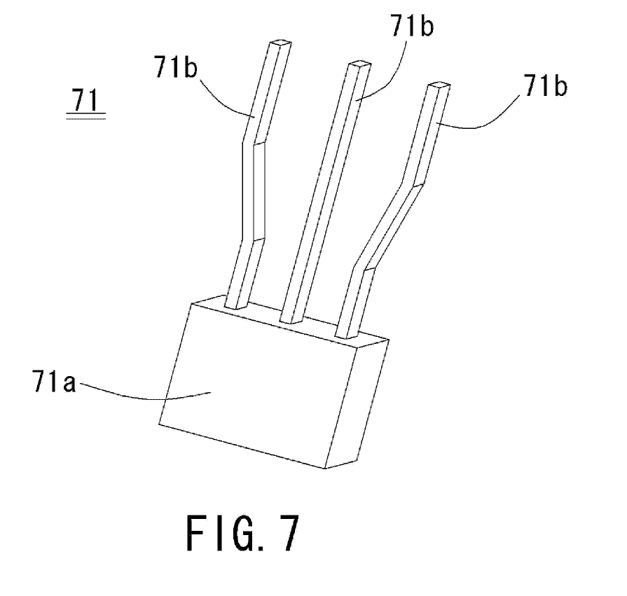

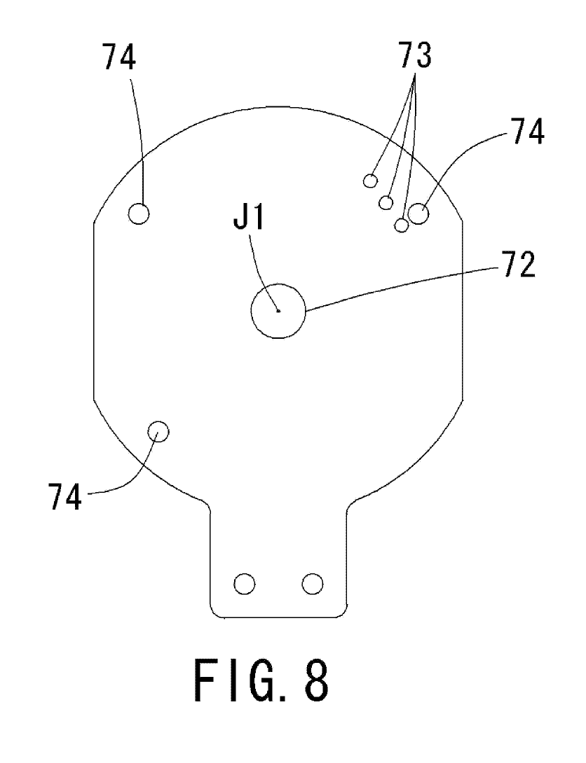

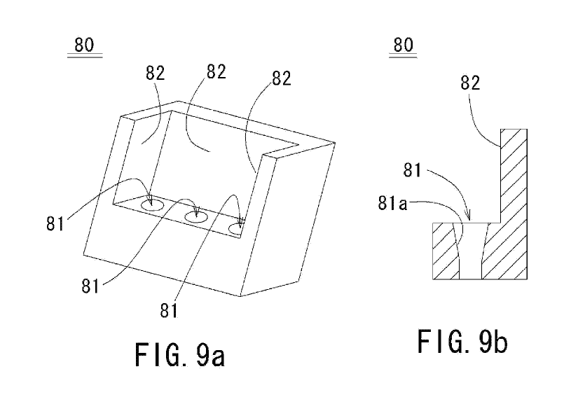

Hereinafter, a configuration of the Hall element 71 and that of the circuit board 70 will be described with reference to FIGS. 7 to 9. FIG. 7 is a perspective drawing of the Hall element 71 according to the present preferred embodiment. FIG. 8 is a schematic plan view of the circuit board 70 as viewed from above. FIG. 9a is a perspective view of a guiding element 80 which will be connected to the Hall element 71 of the present preferred embodiment, while FIG. 9b is a schematic cross sectional view of the guiding element 80 of the present preferred embodiment.

According to FIG. 7, the Hall element 71 includes a detecting portion 71a arranged to detect the magnetic flux of the magnetic drive portion 42, and a plurality of terminals 71b (preferably three terminals in the present preferred embodiment, for example) for connecting the detecting portion 71a and the circuit board 70. Note that the detecting portion 71a is preferably substantially a rectangular solid.

According to FIG. 8, the circuit board 70 includes at an approximate center thereof the through hole 72 through which the protruded portion 11d of the partition 11 is inserted. A diameter of the through hole 72 is greater than the outer diameter of the portion of the circuit board 70 inserted therethrough. Also, a plurality of through holes 73 (preferably, three in the present preferred embodiment, for example) are formed at portions corresponding to the terminals 71b of the circuit board 70, wherein the through holes 73 each have a diameter greater than an outer diameter of the terminals 71b. The Hall element 71 and the circuit board 70 are soldered to one another on the surface of the circuit board 70 opposite from the surface to which the Hall element 71 is connected.

Also, at the portions of the circuit board 70 corresponding to the connecting pins 64, a plurality of pin holes 74 (preferably three in the present preferred embodiment, for example) are formed. A diameter of the pin hole 74 is greater than the outer diameter of the connecting pin 64.

The guiding element 80 shown in FIG. 9 is preferably made of a resin material and formed by an injection molding. Then, a plurality of through holes 81 (preferably three in the present preferred embodiment, for example) for allowing the terminals 71b therethrough are formed on the guiding element 80. Three Hall element supporting surfaces 82 are arranged axially above the through hole 81. Note that one aspect axially above the through hole 81 radially corresponds to the magnetic drive portion 42.

Also, a distance between two Hall element supporting surfaces 82 facing one another in the circumferential direction is slightly greater than a circumferential distance generated by two of the three terminals 71b spaced farthest apart from one another, whereby the Hall element supporting surfaces 82 support the terminals 71b even if any of the terminals 71b is deformed. Consequently, the Hall element supporting surfaces 82 help prevent the terminals 71b from being damaged.

According to FIG. 9b, each through hole 81 includes an inclined surface 81a at which the inner diameter of the through hole 81 is reduced toward the lower portion thereof. The inner diameter of each through hole 81 at the lower portion thereof is substantially equal to the outer diameter of the terminal 71b, and therefore each terminal 71b is easily inserted and securely retained.

### <Connecting Method of the Stator and the Circuit Board>

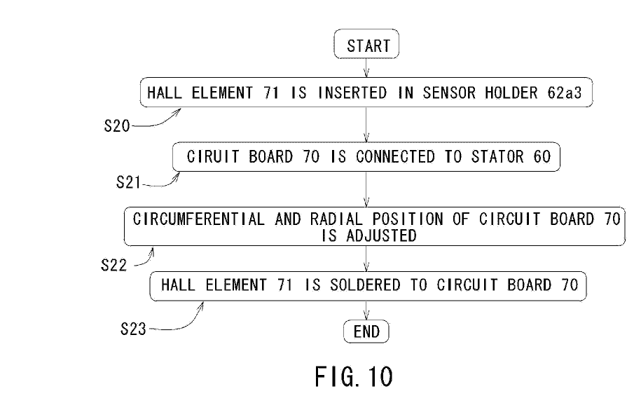

Hereinafter, a connecting method for connecting the stator 60 and the circuit board 70 will be described with reference to FIG. 10. FIG. 10 is a flow chart illustrating a flow of steps of the connecting method for connecting the stator 60 and the circuit board 70.

First, the Hall element 71 is inserted in the sensor holder 62a3 of the insulator 62 of the stator 60 (step S20). Note that only the detecting portion 71a of the sensor holder 62a3 is contained in the sensor holder 62a3 while the terminals 71b protrude from the sensor holder 62a3.

Next, the circuit board 70 is connected to the stator 60 (step S21). Note that the guiding element 80 may be already connected to the circuit board 70 such that the guiding element 80 corresponds to the through holes 73 of the circuit board 70. Each terminal 71b of the Hall element 71 is inserted through the corresponding through hole 81 of the guiding element 80. Also, each connecting pin 64 is inserted to the corresponding pin hole 74.

Next, the circumferential position and the radial position of the circuit board 70 will be adjusted so as not to damage the terminals 71b of the Hall element 71 (step S22). Consequently, the terminals 71b will not be under constant stress, and therefore, the reliability of the Hall element 71 is improved.

Finally, the terminals 71b protruding from the circuit board 70 and an area surrounding them are soldered such that the Hall element 71 is connected to the circuit board 70 (step S23). Also, the connecting pins 64 and the area surrounding them will be soldered such that the connecting pins 64 each are connected to the circuit board 70.

### <Manufacturing Method of the Pump>

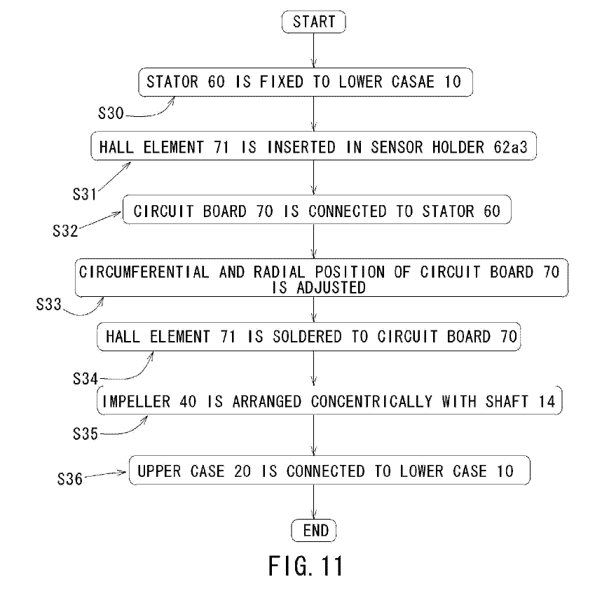

Hereinafter, a manufacturing method of the pump 1 according to a preferred embodiment of the present invention will be described with reference to FIG. 11. FIG. 11 is a flow chart illustrating a flow of steps of the manufacturing method of the pump 1 of the present invention.

First, the stator 60 is arranged at a radial space defined between the outer circumferential surface of the partition 11 and the inner circumferential surface of the case cylindrical portion 12 in the lower case 10 (step S30). Since the innermost surfaces of the tooth portions 61b and the outer circumferential surface of the partition 11 make contact with one another, a center balance of the stator 60 and that of the lower case 10 will be adjusted. By virtue of such configuration, a radial gap generated between the outer circumferential surface of the magnetic drive portion 42 and the innermost surface of the tooth portion 61b will be minimized.

Further, the circumferential position of the stator 60 with respect to the lower case 10 is determined when the ribs 11a1 of the cylindrical portion 11c meet the circumferential gap between two adjacent circumferential direction extending portions 61b1 and the circumferential indent portion 62a6.

Further, an axially end surface of the core back portion 61a makes contact with the step portion 12a of the case cylindrical portion 12, and therefore, the axial position of the stator 60 will be determined with respect to the lower case 10.

Next, the detecting portion 71a of the Hall element 71 will be provided in a space between the outer circumferential surface of the partition 11 and the sensor holder 62a3 (step S31). Note that the guiding element 80 may be previously fixed to the circuit board 70 such that the guiding element 80 corresponds to the through holes 73 of the circuit board 70. Then, each terminal 71b of the Hall element 71 is inserted through the corresponding through hole 81 of the guiding element 80. Also, each connecting pin 64 is inserted to the corresponding pin hole 74. The terminals 71b of the Hall element 71 axially protrude from the sensor holder 62a3 and the bottom portion 11a of the partition 11.

Next, the circuit board 70 is arranged axially below the bottom portion 11a of the lower case 10 (step S32). To be more specific, a portion of the protruded portion 11d of the partition 11 is inserted to the through hole 72 of the circuit board 70. Then, since the top surface of the step portion 11d1 makes contact with the area surrounding the through hole 72, the axial position of the circuit board 70 with respect to the partition 11 will be determined.

Next, the circumferential position and the radial position of the circuit board 70 will be adjusted so as not to damage the terminals 71b of the Hall element 71 (step S33). Consequently, the terminals 71b will be under no stress, and therefore, the reliability of the Hall element 71 is improved. Then, the terminals 71b protruding from the circuit board 70 and an area surrounding them are soldered such that the Hall element 71 is connected to the circuit board 70. Also, the connecting pins 64 and the area surrounding them will be soldered such that the connecting pins 64 each are connected to the circuit board 70.

Further, the protruded portion 11d of the partition 11 is heat sealed at a bottom facing surface of the circuit board 70 so as to connect the circuit board 70 to the partition 11 (step S34). Also, the lower case 10 includes a protruded portion protruding axially downward at the outer circumference thereof. Also, the circuit board 70 includes a through hole corresponding to the protruded portion of the lower case 10. The circuit board 70 and the protruded portion of the lower case 10 are secured to one another by fixing members (e.g., nuts and bolts).

Further, the shaft 14 is affixed in a concentric manner with the rotational axis J1 in the shaft fixing portion 11b of the lower case 10. The shaft 14 may be previously fixed to the lower case 10.

Next, the impeller 40 is arranged in a concentric manner with the shaft 14 (step S35). Then, the upper case 20 is connected to the lower case 10 (step S36).

### <Another Preferred Embodiment>

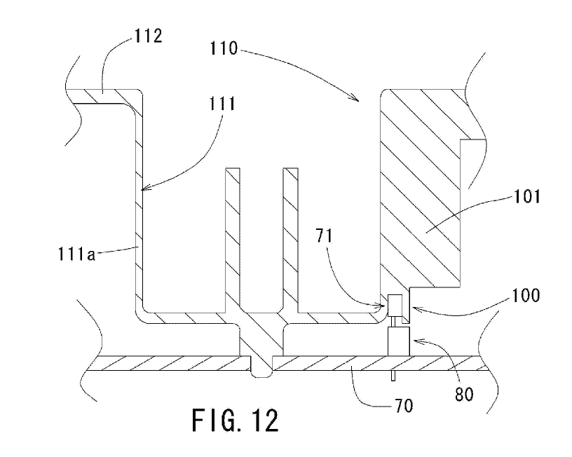

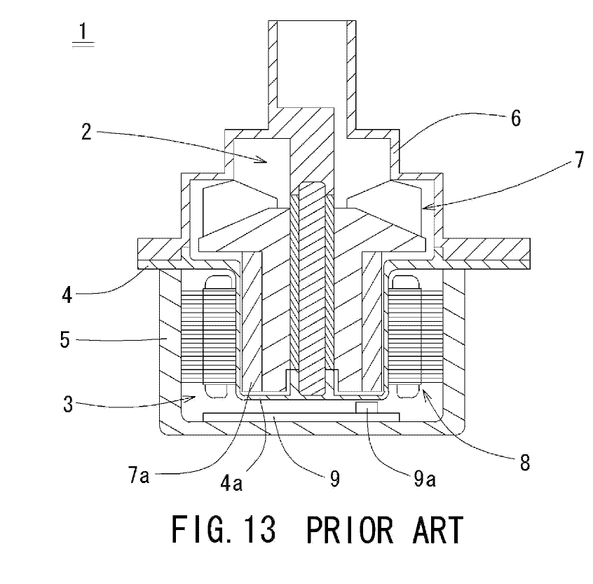

Another preferred embodiment of a sensor holder according to the present invention will be described with reference to FIG. 12. FIG. 12 is a schematic cross sectional view of the sensor holder.

According to FIG. 12, a sensor holder 100 is arranged at an outer circumferential surface of a cylindrical portion 111a of a partition 111 of a case 110. A circumferential rib 101 extending toward a radial direction extending portion 112 of the case 110 is arranged axially above the sensor holder 100. The circumferential rib 101 has a circumferential width that is preferably equal to or smaller than that of the sensor holder 100. Since the circumferential rib 101 is arranged at a space between two adjacent tooth portions (not shown), a circumferential position of the sensor holder 100 with respect to the tooth portions will be determined easily.

While the present invention has been described in detail, the foregoing description is in all aspects illustrative and not restrictive. It is understood that numerous other modifications and variations can be devised without departing from the scope of the present invention.

For example, although it is described above that the number of the Hall element 71 is preferably one, the present invention is not limited thereto. The number of the Hall element 71 may be as many as necessary. Note that in accordance with the number of the Hall elements 71, sensor holders are arranged at the insulator.

For example, although it is described above that the pump 1 is preferably loaded on the stator 60, the present invention is not limited thereto. The present invention may be used in a motor for a general use requiring a magnetic sensor, such as a Hall element. Also, the present invention may be used in a fan using a magnetic sensor, such as a Hall element.

For example, although it is described above that the lower insulator 62a and the upper insulator 62b preferably have the same shape as one another, the present invention is not limited thereto. The lower insulator 62a and the upper insulator 62b may have a different shape from one another. For example, no sensor holder may be arranged on the upper insulator 62b.

For example, although it is described above that the impeller 40 is preferably a single component made of the ferrite magnet, the present invention is not limited thereto. Only the magnetic drive portion 42 may be made of the ferrite magnet. That is, the impeller 40 may be structured such that a magnet is affixed to the magnetic drive portion 42. Also, the material used for the impeller 40 may not be limited to the ferrite magnet, provided that a material commonly used for making a magnetic component is used therefor. Although it is described that the rotor according to the present preferred embodiment includes the impeller 40 including therein the bearing member 43, in the configuration in which an external magnet is used, the rotor includes the impeller 40 including therein the bearing member 43 and the magnet. In such configuration, the rotor including the shaft 14, the bearing member 43, the impeller 40, and the rotor including the external magnet separate from the impeller 40 is ideally formed by an insert molding. Note that the impeller 40 is preferably made of a resin material. When the entire impeller 40 is made of a magnetic material, the cost for manufacturing the impeller 40 will be high. However, if the magnet is used only for the magnetic drive portion 42, and if an appropriate portion of the impeller 40 is made of the magnetic material, the cost for manufacturing the impeller 40 is kept at minimum. Further, if the bearing member 43 is made of resin material by injection molding with the magnet, the bearing member 43, the magnet and the impeller 40 are formed without a seam therebetween, and therefore, no water will be allowed therein. By virtue of such configuration, a reliable motor and or a reliable pump having therein a securely connected magnet, bearing member 40 and the impeller 40 can be provided.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a stator including:
a stator core having a core back portion of a substantially annular shape concentric with a rotational axis, and a plurality of tooth portions arranged in a circumferential manner each extending radially inward toward the rotational axis from the core back portion;
an insulator arranged to cover at least a portion of the plurality of tooth portions, electrically insulating the tooth portions, and including an annular ring arranged at an innermost portion of the tooth portions circumferentially connecting the tooth portions; and
a coil formed by winding a wire multiple times around each of the plurality of tooth portions with the insulator; and
a circuit board having mounted thereon a magnetic sensor arranged opposite to the insulator in an axial direction; wherein
a sensor holder arranged to accommodate therein at least a portion of the magnetic sensor is arranged at the annular ring.

2. The motor according to claim 1, wherein the sensor holder is a portion at least on an inner circumferential surface of the annular ring indented in a radially outward direction.

3. The motor according to claim 2, wherein the sensor holder includes a reduced width portion at which a radial width thereof is reduced.

4. The motor according to claim 2, wherein the sensor holder includes a flat surface that is substantially perpendicular to the rotational axis arranged at a portion thereof that is furthest from the rotational axis.

5. The motor according to claim 2, wherein the sensor holder includes at an outer surface thereof a protruded portion protruded radially inward at which the magnetic sensor makes contact with the sensor holder.

6. The motor according to claim 4, wherein the sensor holder includes at an outer surface thereof a protruded portion protruded radially inward at which the magnetic sensor makes contact with the sensor holder.

7. The motor according to claim 5, wherein the sensor holder includes a bottom surface opposing an axial end surface of the magnetic sensor, and the bottom surface of the sensor holder includes at a portion surrounding the protruded portion an indented portion indented downward.

8. The motor according to claim 1, further comprising a guiding element, wherein the magnetic sensor includes a Hall element that includes a plurality of terminals arranged to connect with the circuit board, and the plurality of terminals each are inserted through one of a plurality of through holes arranged at the guiding element.

9. The motor according to claim 8, wherein the guiding element is connected to the circuit board, and the plurality of through holes of the guiding element each have therein an inclined surface such that the further a portion of the through hole away from the circuit board is the greater the diameter of the through hole is.

10. The motor according to claim 8, wherein the guiding element includes at least two surfaces opposed to one another and arranged to cover two sides of the plurality of terminals arranged axially above the through holes.

11. The motor according to claim 1, wherein the annular ring includes at a surface thereof a plurality of openings in a circumferential direction, a pin is inserted to the opening so as to electrically connect an end portion of the coil, and the pin is also connected electrically to the circuit board.

12. The motor according to claim 1, wherein the core back portion is separate from the plurality of tooth portions.

13. A pump comprising:
a rotor including:
a rotor magnet concentric with a rotational axis; and
an impeller rotating integrally with the rotor magnet;
a stator including:
a stator core having a core back portion of substantially annular shape concentric with the rotational axis, and a plurality of tooth portions arranged in a circumferential manner each extending radially inward toward the rotational axis from the core back portion;
an insulator arranged to cover at least a portion of the plurality of tooth portions, and electrically insulating the tooth portions; and
a coil formed by winding a wire multiple times around each tooth portion with the insulator; and
a circuit board having mounted thereon a magnetic sensor arranged opposite to the insulator in an axial direction;
a lower case including a partition arranged to separate the rotor from the stator, the partition includes a substantially cylindrical portion and a bottom portion; and
an upper case arranged to define, together with the lower case, a pump chamber, the upper case has an intake portion and a discharge portion; wherein
the insulator includes a sensor holder arranged to accommodate at least a portion of a Hall element.

14. The pump according to claim 13, wherein the insulator includes an annular ring arranged at an innermost surface of the plurality of tooth portions, the sensor holder is arranged at an inner circumferential surface of the annular ring, and the sensor holder is arranged radially opposite to the partition and the cylindrical portion.

15. The pump according to claim 14, wherein the sensor holder is a portion on an inner circumferential surface of the annular ring indented in a radially outward direction, and an outer circumferential surface of the partition seals an opening portion of the sensor holder facing inward.

16. The pump according to claim 13, wherein a protruded portion extending axially downward is arranged at the bottom portion of the partition, the circuit board is arranged axially opposite to the bottom portion of the partition, and below the bottom portion, a through hole is arranged at a portion of the circuit board corresponding to the protruded portion for allowing a portion of the protruded portion therethrough, and the circuit board is affixed to the lower case by a deformation of the protruded portion.

17. A motor comprising:
a stator including:
a stator core having a core back portion of substantially annular shape concentric with a rotational axis, and a plurality of tooth portions arranged in a circumferential manner each extending radially inward toward the rotational axis from the core back portion;
an insulator arranged to cover at least a portion of the tooth portions, and electrically insulating the tooth portions; and
a coil formed by winding a wire multiple times around each tooth portion with the insulator; and
a circuit board having mounted thereon a magnetic sensor arranged opposite to the insulator in an axial direction; wherein
the motor has two phases and includes at least one Hall element; and
the insulator includes a sensor holder arranged to accommodate at least a portion of the at least one Hall element.

18. The motor according to claim 17, wherein the motor includes at least four tooth portions, and each coil is formed by winding the wire around each of the at least four tooth portions.

19. A manufacturing method of a stator, the method comprising the steps of:
covering a portion of a plurality of tooth portions of a stator with an insulator from axially top and bottom of the plurality of tooth portions;
winding a wire around each of the plurality of tooth portions including the insulator so as to form a plurality of coils; and
fitting a core back portion to the plurality of tooth portions; wherein
the stator includes a core back portion having a substantially ring shape that is concentric with a rotational axis, and the plurality of tooth portions arranged in a circumferential manner each extending radially inward toward the rotational axis; and
the insulator includes an annular ring arranged at an innermost surface of the tooth portions so as to electrically insulate the tooth portions, the insulator is dividable in an axial direction.

20. The manufacturing method according to claim 19, wherein during the step of winding the wire around each tooth portion, the wire lead between the plurality of tooth portions travels in a contact manner along a circumference of the annular ring so as to continuously form one coil after another.

21. The manufacturing method according to claim 19, wherein at a portion of each of the plurality of tooth portions connected to the core back portion, an extending portion extending substantially perpendicularly with respect to a radial direction of each tooth portion, and the insulator includes an outer cover portion arranged to cover an inner circumferential surface of the extending portion.

22. A connecting method between a stator and a circuit board, the method comprising the steps of:
preparing the stator including:
a stator core having therein a core back portion of a substantially annular shape that is concentric with a rotational axis, and a plurality of tooth portions arranged in a circumferential manner each extending radially inward toward the rotational axis from the core back portion;
an insulator operable to cover at least a portion of the plurality of tooth portions, electrically insulating the tooth portions, and including at a portion thereof a sensor holder accommodating therein at least a portion of a magnetic sensor; and
a coil formed by winding a wire multiple times around each of the plurality of tooth portions with the insulator;
preparing a circuit board having mounted thereon a magnetic sensor arranged opposite to the insulator in an axial direction;
inserting the magnetic sensor in the sensor holder; and
connecting the magnetic sensor to the circuit board.

23. The connecting method between the stator and the circuit board according to claim 22, wherein the magnetic sensor includes a Hall element having a plurality of terminals, a guiding element having a plurality of through holes each operable to allow therein a corresponding terminal is connected to the Hall element, and the guiding element is connected to the Hall element prior to when the Hall element is connected to the circuit board.

24. The connecting method between the stator and the circuit board according to claim 23, wherein the guiding element is previously fixed to the circuit board.

25. A manufacturing method of a pump comprising a rotor, a stator, a circuit board, a lower case and upper case, the method comprising the steps of:
preparing the rotor having a rotor magnet rotating in a concentric manner with a rotational axis, and an impeller rotating integrally with the rotor magnet;
preparing the stator to include:
a stator core including a core back portion having a substantially annular shape concentric with the rotational axis, and a plurality of tooth portions arranged in a circumferential manner each extending radially inward toward the rotational axis from the core back portion;
an insulator arranged to cover at least a portion of the tooth portions, electrically insulating the plurality of tooth portions, and including at a portion thereof a sensor holder accommodating therein at least a portion of a magnetic sensor; and
a coil formed by winding multiple times a wire multiple times around each of the plurality of tooth portions with the insulator;
preparing the circuit board having mounted thereon a magnetic sensor arranged opposite to the insulator in an axial direction;
preparing the lower case including a partition arranged to separate the rotor from the stator, the partition has a substantially cylindrical portion and a bottom portion;
preparing the upper case to form, together with the lower case, a pump chamber, the upper case has an intake portion and a discharge portion;
arranging the stator with respect to the lower case; then inserting the magnetic sensor in the sensor holder; and then connecting the magnetic sensor to the circuit board.

26. The manufacturing method of the pump according to claim 25, wherein the bottom portion of the lower case includes a protruded portion protruding axially downward, the circuit board arranged axially opposite to the circuit board is arranged below the bottom portion, the circuit board includes at a portion thereof corresponding to the protruded portion so as to allow a portion of the protruded portion therethrough, and the method includes between the step of inserting the magnetic sensor in the sensor holder and the step of connecting the magnetic sensor to the circuit board, a step of arranging the circuit board wherein the protruded portion is inserted through the circuit board.

27. The manufacturing method of the pump according to claim 26, wherein the magnetic sensor includes a Hall element having a plurality of terminals, the circuit board includes at a portion thereof a plurality of through holes corresponding to the terminals, the method includes between the step of arranging the circuit board and the connecting the magnetic sensor to the circuit board, a step of connecting the magnetic sensor to the circuit board wherein each terminal is inserted through corresponding through hole of the circuit board, and the method includes a step of adjusting a radial position and circumferential position of the circuit board with respect to the circuit board.
